(19) United States
(12) Patent Application Publication
(10) Pub. No.: US 2015/0083448 A1
(43) Pub. Date: Mar. 26, 2015

(54) ELECTRIC TOOL AND METHOD FOR FASTENING A THREADED MEMBER BY USING IT

(71) Applicant: CHERVON INTELLECTUAL PROPERTY LIMITED, Road Town (VG)

(72) Inventors: Liang Chen, Nanjing (CN); Wu Chen, Nanjing (CN)

(73) Assignee: CHERVON INTELLECTUAL PROPERTY LIMITED

(21) Appl. No.: 14/491,432

(22) Filed: Sep. 19, 2014

(30) Foreign Application Priority Data
Sep. 26, 2013 (CN) 201310444689.2
Sep. 26, 2013 (CN) 201310445173.X

(51) Int. Cl. B25B 23/147; B25B 21/02

(52) U.S. Cl. CPC B25B 23/1475; B25B 21/02
USPC 173/1; 81/464

(57) ABSTRACT

An electric tool and a method for fastening a threaded member by using it, the electric tool has a torque output system and a control system configured to, according to a fastening level selected by a user, invoke a corresponding data to drive the motor to enable it to output with designated single-time impact quantity and impact times.

### RELATED APPLICATION INFORMATION

This application claims the benefit of CN 201310444689.2, filed on Sep. 26, 2013, and CN201310445173.X, filed on Sep. 26, 2013, the disclosures of which are incorporated herein by reference in their entirety.

### FIELD OF THE DISCLOSURE

The subject disclosure generally relates to an electric tool and a control method, and more particularly to an electric tool for outputting impact torque and a method for fastening a threaded member by using the electric tool.

### BACKGROUND

Threaded connection is an extensively used detachable connection and exhibits advantages such as a simple structure, reliable connection and convenient installation and detachment. A threaded member, via its own rotation, is subjected to a pulling force and then a connected member is subjected to a pressure so that two different connected members or one connected member has an enough pretension force.

Upon structure design, the pretension force at a joint of the threaded member should be controlled in a safe scope in order to ensure reliability of the structure, which requires precise control of the fastening degree when the threaded member is fastened. To achieve such control, since the pretension force is not a parameter directly used to guide the fastening action, the prior art mostly employs a direct parameter such as torque as a parameter for controlling the fastening degree, and, on this basis, established many standard values based on threaded members with standard specification.

However, in actual application, more operation conditions do not allow for a desired pretension force to be achieved according to the designer's design, and thus cannot refer to the established standards.

In this case, using a current torsion tool usually cannot effectively accomplish the fastening work and effectively control the fastening degree to ensure the fastening degree is controlled in a certain range.

Furthermore, to achieve control of the fastening degree, currently a torsion tool is usually used for pre-fastening first, and then a torsion meter is used for final torsion determination, which leads to very low efficiency and increases in equipment cost.

The statements in this section merely provide background information related to the present disclosure and do not constitute prior art.

### SUMMARY

Described hereinafter is an electric tool and a method for fastening a threaded member by using the electric tool.

More particularly, an exemplary electric tool, comprises: an output shaft for driving a threaded member, an impact transmission assembly for driving the output shaft intermittently, a motor for driving the impact transmission assembly, and a control system which is capable of driving the motor according to a total impact quantity data which corresponds to a fastening level selected by a user; wherein the total impact quantity data comprises a single-time impact quantity data and an impact times data; the control system comprises a data storage module for storing the total impact quantity data, the single-time impact quantity data and the impact times data.

An exemplary method for fastening a threaded member by using the electric tool described above, comprises:

the control system invokes a total impact quantity data according to the fastening level selected by the user; and

the control system invokes a combination of a set of single-time impact quantity data and impact times data according to the total impact quantity data to drive the motor and enable it to output with designated single-time impact quantity and impact times.

Another exemplary electric tool comprises: an output shaft for driving a threaded member, an impact transmission assembly for driving the output shaft intermittently, a motor for driving the impact transmission assembly, and a control system which is capable of driving the motor according to a combination of rotation speed data and rotation time duration data corresponding to the fastening level selected by the user.

The control system preferably comprises a data storage module configured to store the rotation speed data, the rotation time duration data and the corresponding relationship there between.

Another exemplary method for fastening a threaded member by using the electric tool described above, comprises: the control system invokes a combination of a set of rotation speed data and rotation time duration data to drive the motor according to the fastening level selected by the user.

Further areas of applicability will become apparent from the description provided herein. It should be understood that the description and specific examples are intended for purposes of illustration only and are not intended to limit the scope of the present disclosure.

The present disclosure is advantageous in providing an electric tool for performing output according to a setting to enable a threaded member to be fastened to a designated fastening degree and a method for controlling the fastening degree of a threaded member by using the electric tool.

### BRIEF DESCRIPTION OF THE DRAWINGS

FIG. 1 is a block diagram of an exemplary electric tool constructed according to the present disclosure;

FIG. 2 is a block diagram illustrating a preferred flow of an exemplary method according to the present disclosure;

FIG. 3 is a block diagram of another exemplary electric tool constructed according to the present disclosure;

FIG. 4 is a block diagram illustrating another preferred flow of an exemplary method according to the present disclosure; and

FIG. 5 is a curve diagram showing a corresponding relation between axial stress and axial strain of an outer thread member.

The drawings are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

The following description of the preferred embodiment(s) is merely exemplary in nature and is in no way intended to limit the invention, its application, or uses.

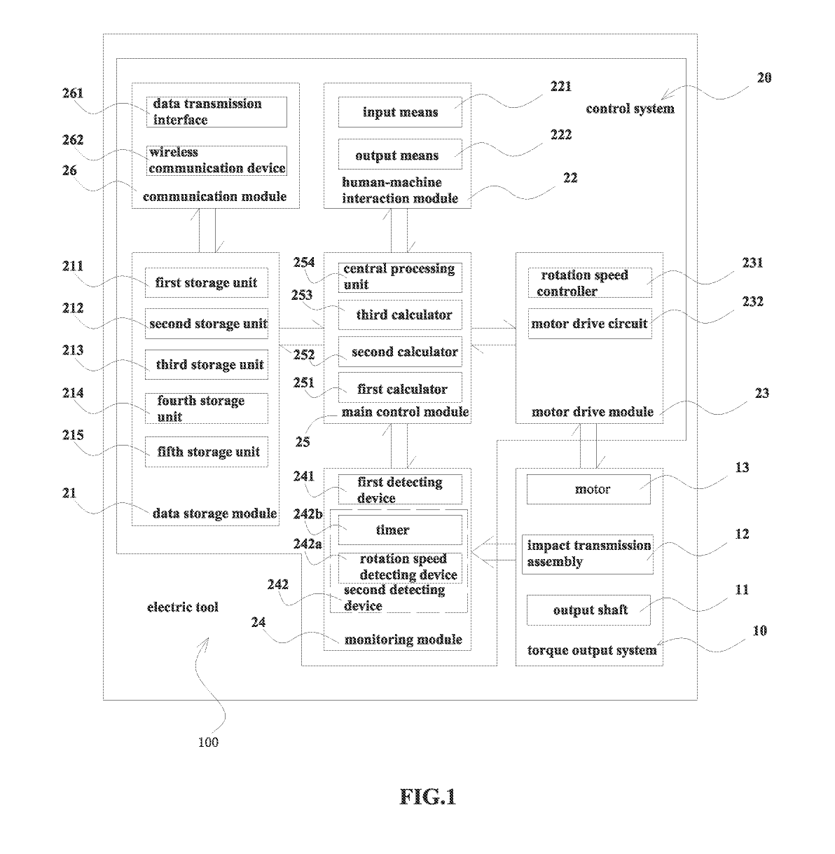

FIG. 1 illustrates an electric tool 100. The electric tool 100 comprises a torque output system 10 and a control system 20.

The torque output system 10 comprises: an output shaft 11, an impact transmission assembly 12 and a motor 13, wherein the output shaft 11 is mainly used to contact a threaded member to make it rotate to complete a fastening action, the impact transmission assembly 12 comprises a hammer anvil capable of impacting the output shaft 11 so that the impact transmission assembly 12 can drive the output shaft 11 in an impact manner, and the motor 13 can drive the impact transmission assembly 12 to rotate under action of electrical energy. Generally, several transmission mechanisms such as gears are provided between a motor shaft of the motor 13 and the impact transmission assembly 12. The above belongs to prior art regarding ordinary impact screwdrivers and impact wrenches, and will not be detailed here.

The control system 20 mainly comprises: a data storage module 21, a human-machine interaction module 22, a motor drive module 23, a monitoring module 24, and a main control module 25.

The main control module 25, according to total impact quantity data corresponding to a fastening level selected by the user, invokes a combination of corresponding single-time impact quantity data and impact times data to drive the motor 13 so that the torque output system 10 outputs with a designated impact total quantity, single-time impact quantity and impact times, while the data storage module 21 can store the total impact quantity data, single-time impact quantity data and impact times data.

Specifically, as shown in FIG. 1, the human-machine interaction module 22 can be operated by the user and feed information back to the user, and the motor drive module 23 can directly drive the motor 11 and control a rotation speed thereof. The monitoring module 24 monitors operation situations of the torque output system 10, and the main control module 25 can control the above modules and receive signals or data fed back from the modules.

As a preferred solution, the human-machine interaction module 22 comprises: an input means 221 for the user to set, and an output means 222 configured to feed information back to the user and prompt the user for information, wherein the input means 221 may be one or more of a button, knob and switch, and the output means 222 may be various visible screens or sound prompting means. When a contactable or touch display screen for contact control is used, the input means 221 and the output means 222 may be integrated as one.

As shown in FIG. 1, the motor drive module 23 comprises a rotation speed controller 231 for controlling the rotation speed of the motor 11, and a motor drive circuit 232 for directly driving the motor 11.

The rotation speed controller 231 controls the rotation speed of the motor 11 mainly by controlling electrical parameters of the motor drive circuit 232 such as current, voltage and duty cycle, and the motor drive circuit 232 is mainly used to provide power to the motor 13, and achieves, through itself, the change and control of parameters of electrical energy supplied to the motor 13 by the rotation speed controller 231.

The monitoring module 24 comprises a first detecting device 241 for detecting whether the torque output system performs impact, and a second detecting device 242 for comprehensively detecting the impact total quantity, single-time impact quantity and impact times.

Specifically, the first detecting device 241 is a means for judging whether impact occurs between the impact transmission assembly 12 and the output shaft 11. As impact mainly occurs between the impact transmission assembly 12 and the output shaft 11 in the torque output system, the function of the first detecting device is to judge and collect various physical signals upon occurrence of impact, such as electrical signal or audio signal, and then feed the information back to the main control module 25. Preferably, the first detecting device 241 may be a sound collecting means such as a microphone, which judges whether impact occurs by receiving the sound signal. After receiving a sound at a specific frequency and/or in a range of sound volume indicative of the occurrence of the impact, the sound collecting means feeds back a signal indicative of the occurrence of the impact to the main controller. Certainly, the impact detecting device 241 may be a position sensor for detecting movement of an impact mechanism 13. When a screw is used, the impact detecting device 241 may further be a distance detector for detecting a distance between a screw cap and a supporting surface of a supporting member, which acquires occurrence time of the impact by detecting the distance. Preferably, the first detecting device 241 is a means capable of collecting current of the motor 13 and judging whether the impact occurs through changes of the current upon impact.

As a further preferred solution, the second detecting device 242 comprises a rotation speed detecting device 242a configured to detect a rotation speed of the impact transmission assembly 12, and a timer 242b configured to measure time length, wherein the rotation speed detecting device 242a may be a means for directly detecting the rotation speed or a means for indirectly obtaining the rotation speed by detecting the electrical parameters of the motor 13.

The main control module 25 comprises: a first calculator 251 configured to invoke the total impact quantity data according to the fastening level selected by the user, a second calculator 252 configured to select corresponding single-time impact quantity data and impact times data according to the total impact quantity data invoked by the first calculator 251, a third calculator 253 configured to calculate according to the total impact quantity data, single-time impact quality data and impact times data invoked by the first calculator 251 and the second calculator 252 to obtain an electrical parameter and a time parameter for driving the motor 13, and a central processing unit 254 for comprehensively controlling the human-machine interaction module 22, the motor drive module 23, the monitoring module 24, as well as the first calculator 251, the second calculator 252 and the third calculator 253.

The first calculator 251 can invoke one impact total quality data according to a signal of the human-machine interaction module 22 after the user selects the fastening level, the second calculator 252 calculates according to the total impact quantity data and invokes a set of single-time impact quality data and impact times data, and the third calculator 253 calculates according to the invoked total impact quantity data, single-time impact quality data and impact times data to obtain electrical parameters for driving the motor 13, such as current, voltage and duty cycle and time parameters, and feeds them back to the central processing unit 254.

As a preferred solution, the data storage module 21 comprises: a first storage unit 211 for pre-storing the total impact quantity data, a second storage unit 212 for pre-storing the single-time impact quantity data corresponding to the total impact quantity data in the first storage unit 211, and a third storage unit 213 for pre-storing the impact time data corresponding to the single-time impact quantity data in the second storage unit 212.

The first storage unit 211, the second storage unit 212 and the third storage unit 213 are mainly used to enable the electric tool 100 to output at a preset fastening level.

When the user selects a preset fastening level, the main control module 25 directly accesses the first storage unit 211, the second storage unit 212 and the third storage unit 213 to invoke the needed data. Since the data corresponds to the preset state, the first storage unit 211, the second storage unit 212 and the third storage unit 213 may employ a storage medium that can only be read but cannot be written over.

Therefore, the purpose of employing the first storage unit 211, the second storage unit 212 and the third storage unit 213 to respectively store the total impact quantity data, single-time impact quantity data and the impact times data is to enable the user to conveniently modify any data in the combination in a self-defined mode.

More preferably, the data storage module 21 further comprises a fourth storage unit 214 in which the user self-defined total impact quantity data, the single-time impact quantity data and the impact times data and corresponding relationship there between are stored, and a fifth storage unit 215 in which the impact total quantity that is set by the user and can be selected in common modes is stored.

The fourth storage unit 214 provides the user with a storage space in the self-defined mode, and the user may, through the human-machine interaction module, set some self-defined fastening levels and corresponding total impact quantity data, single-time impact quantity data and impact times data. As a preferred solution, in order to read and write the fourth storage unit 214 through an apparatus other than the human-machine interaction module 22, the control system 20 further comprises a communication module 26. The communication module 26 comprises a data transmission interface 261 configured to constitute wired data connection between the data storage module 21 and an external apparatus, and a wireless communication device 262 configured to constitute wireless data connection between the data storage module 21 and the external apparatus. The user may perform data interaction with the data storage module 21 via a USB interface or Bluetooth through an apparatus such as a computer or a smart mobile phone.

Noticeably, upon performance of data interaction, a user-oriented application may be pre-installed in the apparatus such as the computer or smart mobile phone.

The fifth storage unit 215 mainly provides the user with a succinct switching mode, namely, user mode: the user will select commonly-used fastening levels including preset fastening levels and self-defined fastening levels and rank them in an order, and upon use, the user may only switch in the commonly-used fastening levels. The fifth storage unit 215 stores total impact quantity data corresponding to the commonly-used fastening levels set by the user and the corresponding order. In the user mode, different commonly-used fastening levels may be switched in an order through the human-machine interaction module 22, and the main controller 25 will invoke different total impact quantity data from the fifth storage unit 215 in turn.

Noticeably, the fifth storage unit 215 may be set through the communication module 26 by using an external apparatus.

A method of controlling fastening degree of the threaded member according to the present disclosure is implemented mainly by virtue of the electric tool 100 as described above.

In general, according to the control method of the present disclosure, the control system 20 in the electric tool 100 of the present disclosure invokes a total impact quantity data and thereby invokes a combination of a set of single-time impact quantity data and impact times data to drive the motor 13 to enable it to output with designated single-time impact quantity and impact times.

A major advantage thereof lies in that the user selects current operation conditions and/or his desired fastening degree, and the main control module 25 can complete the fastening work by invoking the corresponding total impact quantity data, single-time impact quantity data and impact times data.

Principles and details of the control method of the present disclosure are described as follows:

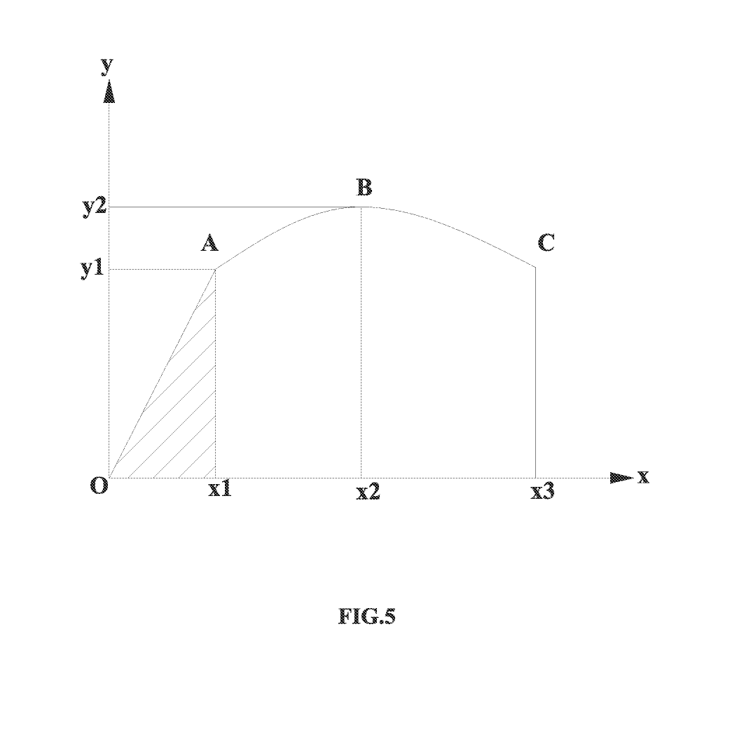

Referring to FIG. 5, axis x represents an axial strain of an outer thread member in the threaded members, and axis y represents an axial tension acting on the outer thread member. Noticeably, based on the relationship between an acting force and a counter-acting force, the axial tension acting on the outer thread member should be equal to the axial stress of the outer thread member, and also equal to a pressure acting on the connected member, namely, a pretension force at the connection of the connected member. It can be seen that the pretension force in the threaded connection is mainly caused by the axial strain of the outer thread member.

As shown in FIG. 5, when the axial strain is smaller than x1, the axial strain is in a linear relationship with the axial tension (equivalent to the pretension force), which indicates that the outer thread member is in an elastic deformation phase; when the axial strain is equal to x1, the axial tension is equal to y1; after the axial strain exceeds x1, the outer thread member is in a plastic deformation phase, and the axial strain will not be in the linear relationship with the axial tension any more. A tendency of the axial tension increasing along with increase of the axial strain becomes slower until the axial strain reaches x2, whereupon the axial tension tends to reduce as the axial strain increases until the tension strain reaches x3 and the outer thread member breaks. Point A is a yield point and a boundary between the elastic deformation and the plastic deformation, and an axial tension y1 at point A is called yield axial tension (yield pretension force). Point B indicates that axial tension of the outer thread member can reach a maximum y2, and y2 is called an extreme axial tension (extreme pretension force).

As known from FIG. 5, when external conditions are certain, and the axial strain of the outer thread member reaches a certain value, the energy allowing for its strain is certain, for example, when the axial strain of the outer thread member is x1, a value of the energy allowing for its strain is an area of a shaded portion of FIG. 5.

During fastening operation in practice, this portion of energy is applied by a torsion tool. If the energy applied by the torsion tool can be controlled, the strain of the outer thread member can be controlled. Since a relation of the strain of the outer thread member and the stress is based on its own properties, a desired axial tension (equivalent to the pretension force) may be obtained by controlling the strain energy of the outer thread member so as to control the fastening degree.

Based on the above principles, the control method according to the present disclosure employs the above-stated electric tool 100 to output torque in an impact manner to drive the threaded member for fastening.

Assuming that the energy transferred to the threaded member through impact by the electric tool 100 before the threaded member fails is e1, e2, e3 . . . eN respectively, but in fact the energy generated through impact cannot be totally used to allow the outer thread member to generate axial strain due to frictional force or other losses. Therefore, the energy actually transferred to the outer thread member to allow it to generate axial strain every time should be k1e1, k2e2, k3e3, . . . kNeN, wherein k1, k2, k3 . . . kN are dimensionless coefficients for balancing energy loss, which are called loss coefficients.

The axial strain energy E of the outer thread member may be obtained through equation (1).

E=k1e1+k2e2+k3e3 . . . +kNeN (1)

As known from the above, the pretension force F is in a correspondence relationship to the axial strain energy E and the axial strain. Therefore, the control of the pretension force may be achieved by controlling the energy transferred by each impact of the electric tool 100 and impact times based on the above.

To achieve such purpose, it is necessary to confirm two variables, namely, the energy of each impact and the loss coefficient. Further, in the case that the impact energy of each time varies, the loss coefficient also changes. Therefore, based on this principle, a target pretension force may be implemented in many different manners. Although a database may be determined and built by means of complicated experiments, this method is not applicable in actual application because the parameters involved in equation (1) are not parameters that can be directly controlled by normal electric tools. The present disclosure makes improvements thereto to enable it to be achieved in specific applications.

First, the energy transferred by the main shaft 12 to the threaded member through impact each time is unified as a constant value e, namely, constant single-time impact quantity, and the equation (2) may be obtained based on the principle of equation (1):

E=(k1+k2+k3 . . . kN)e (2)

As far as identical operation condition and identical single-time impact quantity are concerned, the loss coefficients k1, k2, k3 . . . kN may be measured and calculated in several times and finally determined, so currently the strain energy E is only related to the impact times and the single-time impact quantity e.

Noticeably, the loss coefficient is a parameter that cannot be artificially controlled and meanwhile the single-time impact quantity e is unlikely to be infinitely small, so when load is applied to an outer thread member in the form of impact, it is impossible to obtain a continuous axial stress and strain curve as shown in FIG. 5, but corresponding relationship between value points.

If a high-precision control pretension force is needed, the single-time impact quantity e should be set as an appropriate value in magnitude.

To sum up, as far as a certain operation condition is concerned, a determined single-time impact quantity has a series of given loss coefficients, so a desired impact total quantity and a corresponding pretension force value may be obtained by controlling the impact times.

According to the control method of the present disclosure, automatic control of the fastening procedure is achieved by storing the impact total quantity, single-time impact quantity, impact times, loss coefficient, and electrical parameters of the electric tool 100 corresponding to the impact total quantity and single-time impact quantity in the form of total impact quantity data, single-time impact quantity data and impact times data.

Preferably, the total impact quantity data comprises data information of the impact total quantity; the single-time impact quantity comprises information such as magnitude of the single-time impact quantity and corresponding electrical parameters (such as voltage, current, duty cycle), and loss coefficient of the motor 13; and the impact times data comprise information of the impact times.

As a preferred solution, the human-machine interaction module 22 provides an operation interface for the user to select a fastening level, and feeds back the user's selection to the main control module 25 to allow it to invoke the corresponding total impact quantity data. The main control module 25 invokes the corresponding single-time impact quantity data and impact times data stored in the data storage module 21, and thereby controls the motor drive module 23 to drive the motor 13 according to the invoked single-time impact quantity data and impact times data. After startup of the motor 13, the monitoring module 24 monitors the torque output system and feeds back to the main control module 25 to form a closed-loop control.

Obtainment of a designated single-time impact quantity requires control of instantaneous rotation speed (hereinafter referred to as impact rotation speed) of the impact transmission assembly 12 upon occurrence of impact because the rotation speed is a sole factor for affecting the single-time impact quantity when the structure of the impact transmission assembly 12 is given. As we know, this purpose can be achieved by controlling the electrical parameters of the motor 13. On the basis of controlling the impact speed, a cycle between two times of impact may be fixed by controlling the motor 13, i.e., the impact transmission assembly 12 impacts with a certain impact frequency, which may be achieved by controlling an average rotation speed of the motor 13 in the cycle between two times of impact. The third calculator 253 can calculate a desired impact rotation speed according to the instantly invoked single-time impact quantity data, and calculate a desired time duration (hereinafter referred to as rotation time duration) according to the impact times and the impact frequency.

Therefore, during the control process, the purpose of outputting according to designated impact total quantity, single-time impact quantity and impact times may be indirectly achieved by controlling the rotation speed of the impact transmission assembly 12 (in fact, directly controlling the rotation speed of the motor 13) and rotation time duration.

Preferably, the third calculator 253, according to the total impact quantity data, single-time impact quantity data and impact times data, calculates electrical parameters and time parameter for driving the motor 13 so as to control the motor 13 to enable the impact transmission assembly 12 to output with a certain rotation speed and time duration. The second detecting device 242 comprises: a rotation speed measuring unit 242a configured to detect a rotation speed of the impact transmission assembly and a timer 242b configured to measure time.

After the first detecting device 241 detects the impact for the first time, the second detecting device 242 begins to detect whether the output conforms to the invoked single-time impact quantity data; if yes, begins to measure whether the impact times meet the invoked impact times data; if yes, feeds back a signal for stopping rotation of the motor 13 to the main control module 25.

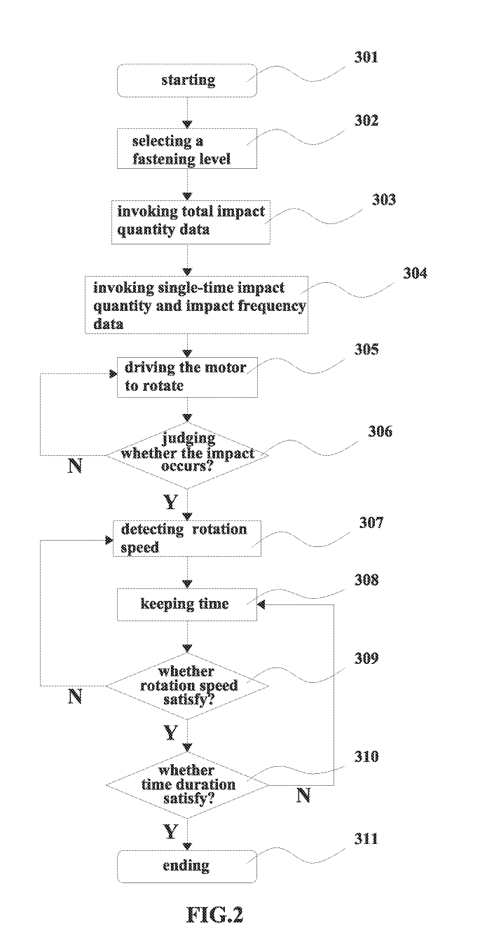

Preferably, the method as shown in FIG. 2 comprises the following control steps:

(301) starting;

(302) operating the human-machine interaction module 22 by the user to select a fastening level;

(303) invoking desired total impact quantity data by the main control module 25 according to the user's selection result;

(304) invoking the single-time impact quantity data and impact times data corresponding to the impact total quantity by the main control module 25;

(305) controlling the motor drive module 23 by the main control module 25 to, according to the invoked single-time impact quantity data, drive the motor 11 to rotate at a designated rotation speed;

(306) detecting whether the impact transmission assembly 12 occurs impact by the first detecting device 241, proceeding to step (307) if yes, or turning back to step (305) if no;

(307) detecting a current rotation speed by the rotation speed detecting device 242a;

(308) beginning to keep time by the timer 242b;

(309) judging whether the rotation speed satisfies, and proceeding to step (310) if yes, or turning back to step (307) if no;

(310) judging whether the time duration date kept by the timer 242b satisfies the total impact quantity data, the single-time impact quantity data and the impact times data invoked by the main control module 25, and proceeding to step (311) if yes, or turning back to step (308) if no; and

(311) ending.

More preferably, the control method according to the present disclosure provides the user with three use modes through the human-machine interaction module 22.

The first mode is a standard mode, i.e., the user can only use a preset fastening level.

The second mode is an expert mode, i.e., the user self-defines some fastening levels and sets self-defined impact total quantity corresponding thereto and configures corresponding self-defined single-time impact quantity data and self-defined impact times data for the self-defined total impact quantity data. In this mode, the user can select a self-set fastening level according to his experience and external data to accomplish the fastening work. The self-set fastening level may be formed by modifying a preset fastening level.

Preferably, the electric tool 100 according to the present disclosure further comprises a torque meter for detecting a magnitude of the torque.

On some occasions that the torque can be considered as the fastening degree standard, the user may use the torque meter to detect whether the settings in the expert mode satisfies his needs.

The third mode is a quick mode, namely, the user stores total impact quantity data corresponding to the commonly-used fastening levels (including preset fastening levels and self-defined fastening levels) in the fifth storage unit 215. In this mode, the user may switch and select from a plurality of fastening levels often used by him via a switching button.

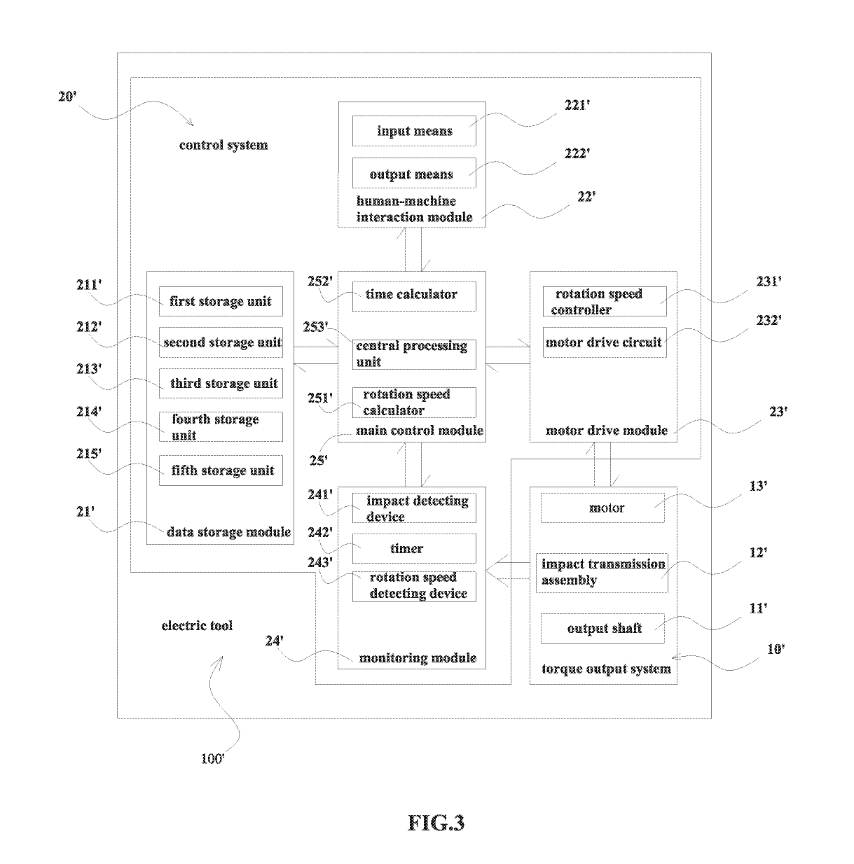

FIG. 3 illustrates another electric tool 100′.

The electric tool 100′ comprises a torque output system 10′

The torque output system 10′ comprises an output shaft 11′ for driving a threaded member, an impact transmission assembly 12′ for driving the output shaft 11′ intermittently, and a motor 13′ for driving the impact transmission assembly 12′,

The electric tool 100′ also comprises a control system 20′ which is capable of driving the motor 13′ according to a combination of rotation speed data and rotation time duration data corresponding to the fastening level selected by the user.

The control system 20′ comprises a data storage module 21′ configured to store the rotation speed data, the rotation time duration data and corresponding relationship there between.

The control system 20′ further comprises a human-machine interaction module 22′ configured to be operated by the user and feed information back to the user; a motor drive module 23′ configured to directly drive the motor 13′ and control its rotation speed; a monitoring module configured to monitor operation situations of the torque output system; and a main control module 25′ configured to receive feedback transmitted from the human-machine interaction module 22′, the data storage module 21′, the motor drive module 23′ and the monitoring module and control them.

The human-machine interaction module 22′ comprises an input means 221′ for the user to set and an output means 222′ configured to feed back to the user and prompt user for information.

The motor drive module 23′ comprises a rotation speed controller 231′ for controlling the rotation speed of the motor 13′ and a motor drive circuit 232′ for directly driving the motor 13′.

The monitoring module comprises an impact detecting device 241′ for judging whether the impact transmission assembly 12′ occurs impact, a timer 242′ for measuring the rotation time duration, and a rotation speed detecting device 243′ for detecting the rotation speed of the impact transmission assembly 12′.

The main control module 25′ comprises a rotation speed calculator configured to invoke a corresponding rotation speed data according to the fastening level selected by the user in the human-machine interaction module 22′, a time calculator 252′ configured to invoke corresponding rotation time duration data according to the fastening level selected by the user in the human-machine interaction module 22′ and the already invoked rotation speed data, and a central processing unit 253′ for comprehensively controlling the rotation speed calculator, the time calculator 252′, the human-machine interaction module 22′, the motor drive module 23′ and the monitoring module.

The data storage module 21′ comprises a first storage unit 211′ for pre-storing a fastening level data corresponding to a preset fastening level in the human-machine interaction module 22′, a second storage unit 212′ for pre-storing the rotation speed data corresponding to the fastening level data in the first storage unit 211′, a third storage unit 213′ for pre-storing the rotation time duration data corresponding to the rotation speed data in the second storage unit 212′, a fourth storage unit 214′ in which user self-defined fastening level data, rotation speed data, rotation time duration data and corresponding relationship therebetween are stored, and a fifth storage unit 215′ in which the fastening level data commonly used by the user are stored.

Another method for fastening a threaded member based on the above, comprises: the control system 20′ invoking a combination of a set of rotation speed data and rotation time duration data to drive the motor 13′ according to the fastening level selected by the user.

Preferably, the human-machine interaction module 22′ provides an operation interface for the user to select a fastening level, and feeds back the user's selection result to the main control module 25′ to allow it to invoke the corresponding fastening level data, and then the main control module 25′ invokes the corresponding rotation speed data and rotation time duration data stored in the data storage module 21′, and uses their combination to control the motor drive module 23′ to enable it to drive the motor 13′ according to instant data; wherein after startup of the motor 13′, the monitoring module monitors the torque output system and feeds back to the main control module 25′ to form a closed-loop control.

Preferably, after the impact detecting device 241′ of the monitoring module detects the impact, and when the timer 242′ begins to keep time, the rotation speed detecting device 243′ detects whether the rotation speed of the motor 13′ conforms to the currently invoked rotation speed data, and a signal for stopping rotation of the motor 13′ is fed back to the main control module 25′ when the rotation time duration recorded by the timer 242′ conforms to the currently invoked rotation time duration data.

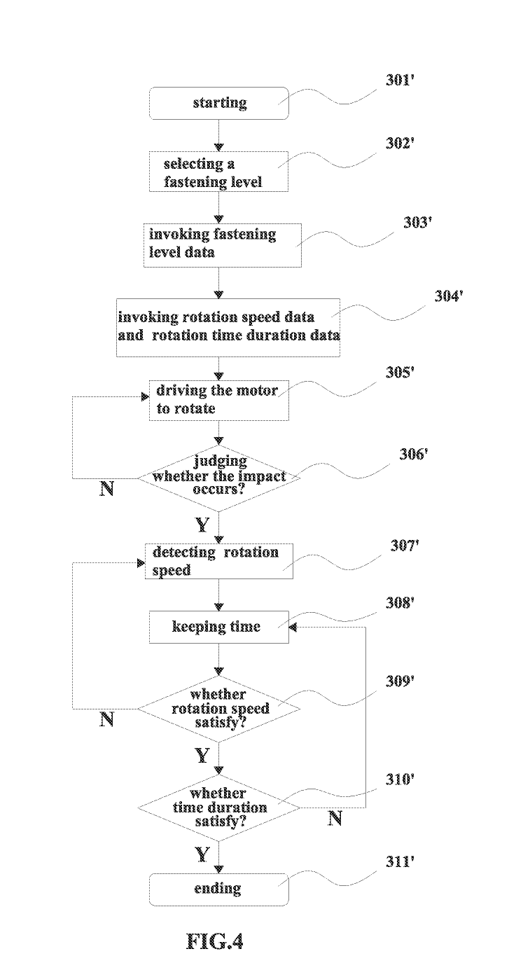

Preferably, the method as shown in FIG. 4 comprises the following control steps:

(301′) starting;

(302′) operating the human-machine interaction module 22′ by the user to select a desired fastening level;

(303′) invoking the fastening level data in the data storage module 21′ by the main control module 25′ according to the user's selection result;

(304′) invoking the rotation speed data and the rotation time duration data corresponding to the fastening level data by the main control module 25′ according to the invoked fastening level data;

(305′) controlling the motor drive module 23′ by the main control module 25′ to drive the motor 13′ to rotate according to the invoked rotation speed data;

(306′) detecting whether the impact transmission assembly 12′ occurs impact by the impact detecting device 241′, proceeding to step (7) if yes, or turning back to step (5) if no;

(307′) detecting a current rotation speed by the rotation speed detecting device 243′;

(308′) beginning to keep time by the timer 242′;

(309′) judging whether the rotation speed satisfies, and proceeding to step (10) if yes, or turning back to step (7) if no;

(310′) judging whether the kept rotation time duration satisfies the rotation time duration data invoked by the main control module 25′, and proceeding to step (11) if yes, or turning back to step (8) if no;

(311′) ending.

Preferably, the fastening level data comprises preset fastening level data stored in the first storage unit 211′ and self-defined fastening level data which are stored in the fourth storage unit 214′ and self-defined and set by the user as required; wherein the data storage module 21′ stores preset rotation speed data and preset rotation time duration data corresponding to the preset fastening level data.

The above illustrates and describes basic principles, main features and advantages of the present disclosure. Those skilled in the art should appreciate that the embodiments by no means limit the present disclosure. All technical solutions obtained by employing equivalent substitutes or equivalent variations fall within the protection scope of the present disclosure.

What is claimed is:

1. An electric tool, comprising:
an output shaft for driving a threaded member;
an impact transmission assembly for driving the output shaft intermittently;
a motor for driving the impact transmission assembly; and
a control system which drives the motor according to a total impact quantity data which corresponds to a fastening level selected by a user;
wherein the total impact quantity data comprises a single-time impact quantity data and an impact times data and wherein the control system comprises a data storage module for storing the total impact quantity data, the single-time impact quantity data and the impact times data.

2. The electric tool according to claim 1, wherein the control system further comprises:
a human-machine interaction module configured to be operated by the user;
a motor drive module configured to directly drive and control the motor;
a monitoring module configured to monitor operation situations of the torque output system; and
a main control module configured to receive feedback signals from the human-machine interaction module, the data storage module, the motor drive module and the monitoring module and to control the human-machine interaction module, the data storage module, the motor drive module and the monitoring module.

3. The electric tool according to claim 2, wherein the human-machine interaction module comprises an input means for the user to operate, and an output means configured to feed information back to the user and prompt the user for information and wherein the motor drive module comprises a motor drive circuit for directly driving the motor and a rotation speed controller for controlling the rotation speed of the motor and the monitoring module comprises a first detecting device for detecting whether the output shaft performs impact, and a second detecting device for comprehensively detecting the motor and the impact transmission assembly.

4. The electric tool according to claim 2, wherein the main control module comprises:
a first calculator configured to invoke the total impact quantity data according to the fastening level selected by the user;
a second calculator configured to select corresponding single-time impact quantity data and impact times data according to the total impact quantity data invoked by the first calculator;
a third calculator configured to calculate according to the total impact quantity data, the single-time impact quality data and the impact times data invoked by the first calculator and the second calculator to obtain electrical parameters and a time parameter for driving the motor; and
a central processing unit for comprehensively controlling the human-machine interaction module, the motor drive module, the monitoring module, as well as the first calculator, the second calculator and the third calculator.

5. The electric tool according to claim 1, wherein the data storage module comprises:
a first storage unit for storing the total impact quantity data;
a second storage unit for storing the single-time impact quantity data corresponding to the total impact quantity data in the first storage unit;
a third storage unit for storing the impact time data corresponding to the single-time impact quantity data in the second storage unit;
a fourth storage unit in which a user self-defined total impact quantity data, single-time impact quantity data, impact times data and corresponding relationship there between are stored; and
a fifth storage unit in which the total impact quantity data corresponding to commonly-used fastening levels set by the user are stored.

6. A method for fastening a threaded member by using an electric tool comprising an output shaft for driving a threaded member, an impact transmission assembly for driving the output shaft intermittently, a motor for driving the impact transmission assembly, and a control system which drives the motor according to a total impact quantity data which corresponds to a fastening level selected by a user, wherein the total impact quantity data comprises a single-time impact quantity data and an impact times data and wherein the control system comprises a data storage module for storing the total impact quantity data, the single-time impact quantity data and the impact times data, the method comprising:
causing the control system to invoke a total impact quantity data according to a fastening level selected by the user; and
causing the control system to invoke a combination of a set of single-time impact quantity data and impact times data according to the total impact quantity data to drive the motor and enable the motor to generate an output with a designated single-time impact quantity and impact times.

7. The method for fastening a threaded member according to claim 6, wherein the control system further comprises:
a human-machine interaction module configured to be operated by the user;
a motor drive module configured to directly drive and control the motor;
a monitoring module configured to monitor operation situations of the torque output system; and
a main control module configured to receive feedback signals from the human-machine interaction module, the data storage module, the motor drive module and the monitoring module and control the human-machine interaction module, the data storage module, the motor drive module and the monitoring module;
wherein the human-machine interaction module provides an operation interface for the user to select a fastening level, and feeds back the user's selection to the main control module to allow the main control module to invoke the corresponding total impact quantity data; the main control module invokes the corresponding single-time impact quantity data and impact times data stored in the data storage module and controls the motor drive module to drive the motor according to the invoked single-time impact quantity data and impact times data; after startup of the motor, the monitoring module monitors the torque output system and feeds back to the main control module to form a closed-loop control.

8. The method for fastening a threaded member according to claim 7, wherein the monitoring module comprises a first detecting device for detecting whether the output shaft performs impact, and a second detecting device for comprehensively detecting the motor and the impact transmission assembly; and
wherein after the first detecting device detects the impact for the first time, the second detecting device begins to detect whether the rotation of the impact transmission assembly conforms to the invoked single-time impact quantity data and, if rotation is detected, the second detecting device begins to measure whether the impact times conform to the invoked impact times data and, if rotation is not detected, the second detecting device feeds back a signal for stopping rotation of the motor to the main control module.

9. The method for fastening a threaded member according to claim 8, wherein the main control module comprises:
a first calculator configured to invoke the total impact quantity data according to the fastening level selected by the user;
a second calculator configured to select corresponding single-time impact quantity data and impact times data according to the total impact quantity data invoked by the first calculator;
a third calculator configured to calculate according to the total impact quantity data, the single-time impact quality data and the impact times data invoked by the first calculator and the second calculator to obtain electrical parameters and time parameter for driving the motor; and
a central processing unit for comprehensively controlling the human-machine interaction module, the motor drive module, the monitoring module, as well as the first calculator, the second calculator and the third calculator;
wherein the third calculator, according to the total impact quantity data, the single-time impact quantity data and the impact times data, calculates the electrical parameters and the time parameter for driving the motor, the central processing unit, according to operation results of the third calculator, controls the motor to enable the impact transmission assembly to output with the designated rotation speed and rotation time duration, and the second detecting device comprises a rotation speed measuring unit configured to detect the rotation speed of the impact transmission assembly and a timer configured to measure time.

10. The method for fastening a threaded member according to claim 9, wherein the data storage module comprises:
a first storage unit for storing the total impact quantity data;
a second storage unit for storing the single-time impact quantity data corresponding to the total impact quantity data in the first storage unit;
a third storage unit for storing the impact time data corresponding to the single-time impact quantity data in the second storage unit;
a fourth storage unit in which user self-defined total impact quantity data, single-time impact quantity data, impact times data and corresponding relationship there between are stored; and
a fifth storage unit in which the total impact quantity data corresponding to commonly-used fastening levels set by the user are stored;
wherein the total impact quantity data comprise preset total impact quantity data stored in the first storage unit and self-defined total impact quantity data which are stored in the fourth storage unit and self-defined and set by the user as required and the data storage module stores preset single-time impact quantity data and preset impact times data corresponding to the preset total impact quantity data.

11. An electric tool, comprising:
an output shaft for driving a threaded member;
an impact transmission assembly for driving the output shaft intermittently;
a motor for driving the impact transmission assembly; and
a control system which drives the motor according to a combination of rotation speed data and rotation time duration data corresponding to the fastening level selected by the user;
wherein the control system comprises a data storage module configured to store the rotation speed data, the rotation time duration data and corresponding relationship there between.

12. The electric tool according to claim 11, wherein the control system further comprises:
a human-machine interaction module configured to be operated by the user and feed information back to the user;
a motor drive module configured to directly drive the motor and control its rotation speed;
a monitoring module configured to monitor operation situations of the torque output system; and
a main control module configured to receive feedback transmitted from the human-machine interaction module, the data storage module, the motor drive module and the monitoring module and control the human-machine interaction module, the data storage module, the motor drive module and the monitoring module.

13. The electric tool according to claim 12, wherein the human-machine interaction module comprises an input means for the user to select a fastening level and an output means configured to feed back to the user and prompt user for information, the motor drive module comprises a rotation speed controller for controlling the rotation speed of the motor and a motor drive circuit for directly driving the motor, and the monitoring module comprises an impact detecting device for judging whether the impact transmission assembly occurs impact, a timer for measuring the rotation time duration, and a rotation speed detecting device for detecting the rotation speed of the impact transmission assembly.

14. The electric tool according to claim 2, wherein the main control module comprises:
a rotation speed calculator configured to invoke a corresponding rotation speed data according to the fastening level selected by the user in the human-machine interaction module;
a time calculator configured to invoke corresponding rotation time duration data according to the fastening level selected by the user in the human-machine interaction module and the already invoked rotation speed data; and
a central processing unit for comprehensively controlling the rotation speed calculator, the time calculator, the human-machine interaction module, the motor drive module and the monitoring module.

15. The electric tool according to claim 11, wherein the data storage module comprises:
a first storage unit for pre-storing a fastening level data corresponding to a preset fastening level in the human-machine interaction module;
a second storage unit for pre-storing the rotation speed data corresponding to the fastening level data in the first storage unit;
a third storage unit for pre-storing the rotation time duration data corresponding to the rotation speed data in the second storage unit;
a fourth storage unit in which user self-defined fastening level data, rotation speed data, rotation time duration data and corresponding relationship there between are stored; and
a fifth storage unit in which the fastening level data commonly used by the user are stored.

16. A method for fastening a threaded member by using an electric tool comprising an output shaft for driving a threaded member, an impact transmission assembly for driving the output shaft intermittently, a motor for driving the impact transmission assembly, and a control system which drives the motor according to a combination of rotation speed data and rotation time duration data corresponding to the fastening level selected by the user, wherein the control system comprises a data storage module configured to store the rotation speed data, the rotation time duration data and corresponding relationship there between, the method comprising:
causing the control system to invoke a combination of a set of rotation speed data and rotation time duration data to drive the motor according to the fastening level selected by the user.

17. The method for fastening a threaded member according to claim 16, wherein the control system further comprises a data storage module configured to store the rotation speed data, the rotation time duration data and the corresponding relationship there between, a human-machine interaction module configured to be operated by the user and feed information back to the user, a motor drive module configured to directly drive the motor and control its rotation speed, a monitoring module configured to monitor operation situations of the torque output system, and a main control module configured to receive feedback transmitted from the human-machine interaction module, the data storage module, the motor drive module and the monitoring module and control the human-machine interaction module, the data storage module, the motor drive module and the monitoring module;
wherein the human-machine interaction module provides an operation interface for the user to select a fastening level, and feeds back the user's selection to the main control module to allow the main control module to invoke the corresponding fastening level data whereupon the main control module invokes the corresponding rotation speed data and rotation time duration data stored in the data storage module and uses their combination to control the motor drive module to enable it to drive the motor according to instant data and wherein after startup of the motor, the monitoring module monitors the torque output system and feeds back the monitored torque output to the main control module to form a closed-loop control.

18. The method for fastening a threaded member according to claim 17, wherein the monitoring module comprises an impact detecting device for judging whether the impact transmission assembly occurs impact, a timer for measuring a rotation time duration, and a rotation speed detecting device for detecting the rotation speed of the impact transmission assembly and wherein after the impact detecting device of the monitoring module detects the impact, and when the timer begins to keep time, the rotation speed detecting device detects whether the rotation speed of the motor conforms to the currently invoked rotation speed data, and a signal for stopping rotation of the motor is fed back to the main control module when the rotation time duration recorded by the timer conforms to the currently invoked rotation time duration data.

19. The method for fastening a threaded member according to claim 18, wherein the method comprises the following control steps:
(1) starting;
(2) operating the human-machine interaction module by the user to select a desired fastening level;
(3) invoking the fastening level data in the data storage module by the main control module according to the user's selection result;
(4) invoking the rotation speed data and the rotation time duration data corresponding to the fastening level data by the main control module according to the invoked fastening level data;
(5) controlling the motor drive module by the main control module to drive the motor to rotate according to the invoked rotation speed data;
(6) detecting whether the impact transmission assembly occurs impact by the impact detecting device, proceeding to step (7) if yes, or turning back to step (5) if no;
(7) detecting a current rotation speed by the rotation speed detecting device;
(8) beginning to keep time by the timer;
(9) judging whether the rotation speed satisfies, and proceeding to step (10) if yes, or turning back to step (7) if no;
(10) judging whether the kept rotation time duration satisfies the rotation time duration data invoked by the main control module, and proceeding to step (11) if yes, or turning back to step (8) if no; and
(11) ending.

20. The method for fastening a threaded member according to claim 19, wherein the data storage module comprises a first storage unit for pre-storing the fastening level data corresponding to the preset fastening level in the human-machine interaction module, a second storage unit for pre-storing the rotation speed data corresponding to the fastening level data in the first storage unit, a third storage unit for pre-storing the rotation time duration data corresponding to the rotation speed data in the second storage unit, a fourth storage unit in which user self-defined fastening level data, rotation speed data, rotation time duration data and corresponding relationship therebetween are stored, and a fifth storage unit in which the fastening level data commonly used by the user are stored; and
wherein the fastening level data comprises preset fastening level data stored in the first storage unit and self-defined fastening level data which are stored in the fourth storage unit and self-defined and set by the user as required and wherein the data storage module stores preset rotation speed data and preset rotation time duration data corresponding to the preset fastening level data.
